(19) United States
(12) Patent Application Publication
(10) Pub. No.: US 2026/0082299 A1
(43) Pub. Date: Mar. 19, 2026

(54) COMMUNICATION CONTROL DEVICE AND COMMUNICATION CONTROL METHOD

(71) Applicant: 1FINITY Inc., Kawasaki-shi (JP)

(72) Inventor: Takahiro MIYAZAKI, Saitama (JP)

(73) Assignee: 1FINITY Inc., Kawasaki-shi (JP)

(21) Appl. No.: 19/325,932

(22) Filed: Sep. 11, 2025

(30) Foreign Application Priority Data
Sep. 17, 2024 (JP) 2024-160514

(51) Int. Cl. H04W 36/30; H04W 36/08

(52) U.S. Cl. CPC H04W 36/30; H04W 36/08

(57) ABSTRACT

A communication control device includes: a memory; and a processor coupled to the memory and the processor configured to: receive quality information indicating communication quality and load information indicating a communication load for each of a plurality of cells adjacent to a specific cell from a base station device; specify any one of the plurality of cells as a first cell on which a terminal device located in the specific cell performs handover at a predetermined timing on a basis of the load information and the quality information for each of the plurality of cells at the predetermined timing; and transmit information indicating the specified first cell to the base station device.

### CROSS-REFERENCE TO RELATED APPLICATION

This application is based upon and claims the benefit of priority of the prior Japanese Patent Application No. 2024-160514, filed on Sep. 17, 2024, the entire contents of which are incorporated herein by reference.

### FIELD

The present invention relates to a communication control device and a communication control method.

### BACKGROUND

In recent years, as one of self-organizing networks (SON) techniques in a wireless communication system, mobility load balancing (MLB) for switching base station devices to which terminal devices are connected according to a load state of each of the base station devices has appeared (see, for example, JP 2022-105305 A, WO 2023/042459 A, WO 2023/157363 A, and JP 2023-066415 A).

However, in the mobility load balancing as described above, for example, a load state in each base station device is used as a balancing determination criterion. Therefore, in the mobility load balancing as described above, for example, communication quality in a terminal device may be degraded.

### SUMMARY

A communication control device includes: a memory; and a processor coupled to the memory and the processor configured to: receive quality information indicating communication quality and load information indicating a communication load for each of a plurality of cells adjacent to a specific cell from a base station device; specify any one of the plurality of cells as a first cell on which a terminal device located in the specific cell performs handover at a predetermined timing on a basis of the load information and the quality information for each of the plurality of cells at the predetermined timing; and transmit information indicating the specified first cell to the base station device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is diagram for explaining a configuration of the wireless communication system 10.

FIG. 2 is diagram for explaining a configuration of the wireless communication system 10.

FIG. 3 is a diagram for explaining a specific example of the load balancing among the base station devices 1 performed by the communication control device 3.

FIG. 4 is a diagram for explaining a hardware configuration of the base station device 1.

FIG. 5 is a diagram for explaining a hardware configuration of the terminal device 2.

FIG. 6 is a diagram for explaining a hardware configuration of the communication control device 3.

FIG. 7 is a diagram for explaining functions of the base station device 1 in the first embodiment.

FIG. 8 is a diagram for explaining functions of the terminal device 2 in the first embodiment.

FIG. 9 is a diagram for explaining functions of the communication control device 3 in the first embodiment.

FIG. 10 is a sequence chart of communication control process in the first embodiment.

FIG. 11 is a flowchart for explaining the performance information accumulation process.

FIG. 12 is a flowchart for explaining the policy generation process.

FIG. 13 is a flowchart for explaining the policy update process.

FIG. 14 is a flowchart for explaining the measurement information accumulation process.

FIG. 15 is a flowchart for explaining the value calculation process.

FIG. 16 is a flowchart for explaining the cell specifying process.

FIG. 17 is a flowchart for explaining the information transmission process.

FIG. 18 is a flowchart for explaining details of S22.

FIG. 19 is a flowchart for explaining details of S23.

FIG. 20 is a diagram for explaining a specific example of the performance information DT2.

FIG. 21 is a diagram for explaining the communication control process.

FIG. 22 a diagram for explaining the communication control process.

FIG. 23 is a diagram for explaining a specific example of the policy information DT3.

FIG. 24 is a diagram for explaining a specific example of the measurement information DT1.

FIG. 25 is a diagram for explaining a specific example of the aggregation information DT4a.

FIG. 26 is a diagram for explaining a specific example of the aggregation information DT4b.

FIG. 27 is a diagram for explaining the communication control process.

FIG. 28 is a diagram for explaining the communication control process.

### DESCRIPTION OF EMBODIMENTS

Hereinafter, an embodiment of the present disclosure will be described with reference to the drawings. However, such description is not to be construed in a limiting sense and does not limit the claimed subject matter. In addition, various changes, substitutions, and modifications can be made without departing from the gist and scope of the present disclosure. In addition, different embodiments can be appropriately combined.

### Configuration of Wireless Communication System in First Embodiment

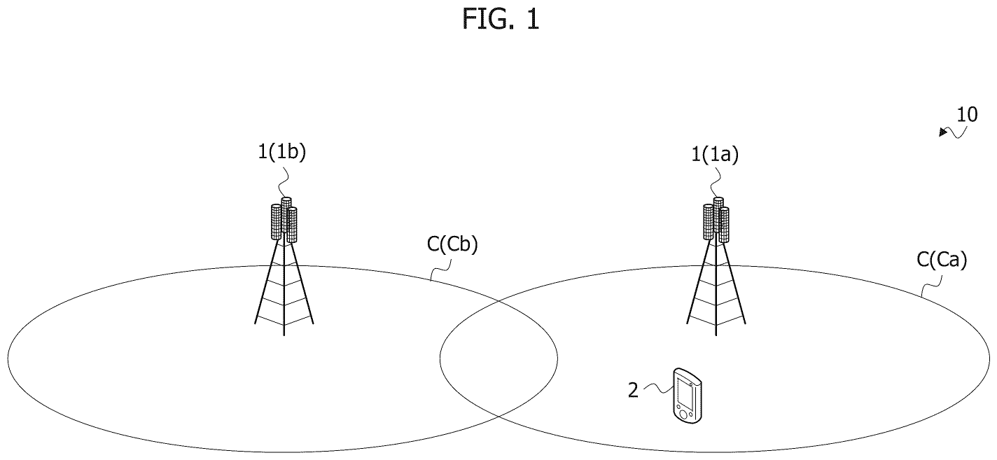

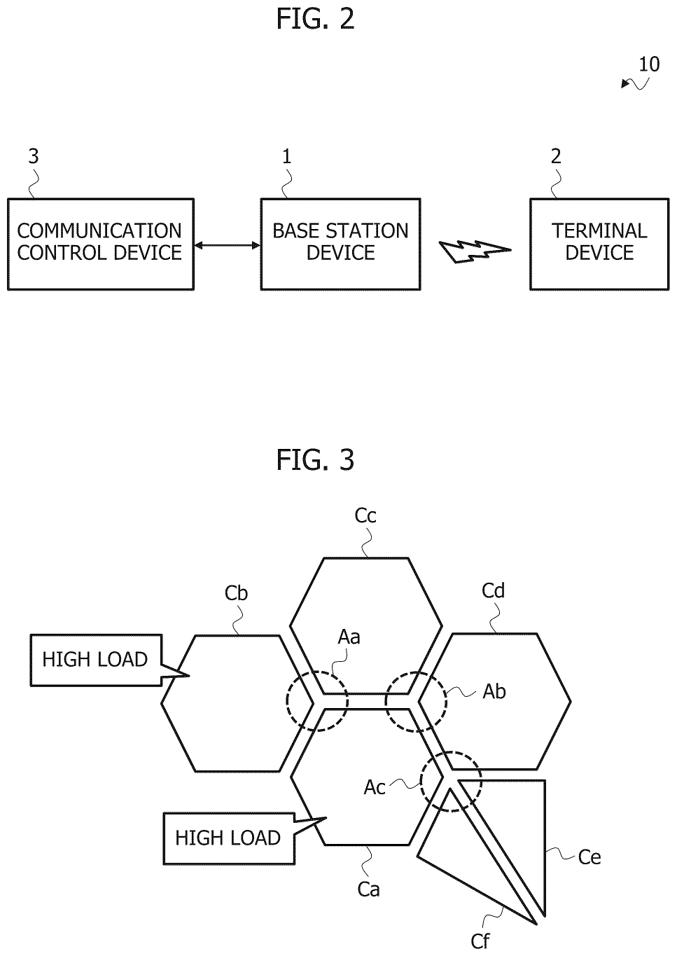

First, a configuration of a wireless communication system 10 will be described. FIGS. 1 and 2 are diagrams for explaining a configuration of the wireless communication system 10.

As illustrated in FIG. 1, for example, the wireless communication system 10 includes a base station device 1a, a base station device 1b, and a terminal device 2. Hereinafter, the base station device 1a and the base station device 1b are also collectively referred to simply as a base station device 1.

As illustrated in FIG. 1, for example, the base station device 1a forms a cell Ca. For example, the base station device 1b forms a cell Cb. Hereinafter, the cell Ca and the cell Cb are also collectively referred to simply as a cell C. In the example illustrated in FIG. 1, for example, the terminal device 2 is located in the cell Ca and performs wireless connection with the base station device 1a.

Note that, for example, the wireless communication system 10 may be a wireless communication system corresponding to a communication standard of a 5th generation mobile communication system (5G) or a communication standard of a generation after 5G.

For example, the terminal device 2 may be a terminal device such as a smartphone possessed by an individual, or an IoT device installed outdoors or the like. In the following description, it is assumed that one terminal device 2 is located in the cell Ca, but for example, another number of terminal devices 2 may be located in the cell Ca.

In the following description, it is assumed that the terminal device 2 is not located in the cell Cb, but for example, one or more terminal devices 2 may be located in the cell Cb. In the following description, it is assumed that the wireless communication system 10 includes two base station devices 1, but for example, the wireless communication system 10 may include another number of base station devices 1.

In addition, as illustrated in FIG. 2, for example, the wireless communication system 10 includes a communication control device 3 in addition to the base station device 1 and the terminal device 2.

For example, the communication control device 3 is one or more physical machines or virtual machines, and performs a process of controlling communication between the base station device 1 and the terminal device 2 and load balancing among the base station devices 1 (hereinafter, also referred to as communication control process). Hereinafter, a specific example of the load balancing among the base station devices 1 performed by the communication control device 3 will be described.

### Specific Example of Load Balancing

FIG. 3 is a diagram for explaining a specific example of the load balancing among the base station devices 1 performed by the communication control device 3. Note that, in the following description, it is assumed that a cell Ca and a cell Cb illustrated in FIG. 3 correspond to the cell Ca and the cell Cb described with reference to FIG. 1, respectively.

In the example illustrated in FIG. 3, the cell Cb, the cell Cc, the cell Cd, the cell Ce, and the cell Cf exist around the cell Ca. Hereinafter, another cell C existing around a cell C is also referred to as an adjacent cell C.

In addition, in the example illustrated in FIG. 3, for example, a contention area Aa which is an area in which wireless connection can be performed with each of the base station device 1a corresponding to the cell Ca, the base station device 1b corresponding to the cell Cb, and the base station device 1 corresponding to the cell Cc exists at a boundary among the cell Ca, the cell Cb, and the cell Cc. Similarly, for example, a contention area Ab exists at a boundary among the cell Ca, the cell Cc, and the cell Cd. In addition, for example, a contention area Ac exists at a boundary among the cell Ca, the cell Cd, the cell Ce, and the cell Cf. Hereinafter, the contention area Aa, the contention area Ab, and the contention area Ac are also collectively referred to simply as a contention area A.

When a user who possesses the terminal device 2 (hereinafter, also simply referred to as a user) moves from the cell Ca to the cell Cb and the user passes through the contention area Aa, for example, the communication control device 3 selects any one of the cell Ca, the cell Cb, and the cell Cc as a cell C to perform wireless connection with the terminal device 2 while the user is moving in the contention area Aa.

Specifically, as illustrated in FIG. 3, when a load in each of the cell Ca and the cell Cb is higher than that in any one of other cells C including the cell Cc, for example, the communication control device 3 selects the cell Cc having a lower load than the cell Ca and the cell Cb as a cell to be connected when the terminal device 2 passes through the contention area Aa. That is, in this case, for example, the terminal device 2 performs handover (HO) from the cell Ca to the cell Cc in response to the user moving from the cell Ca (an area other than the contention area Aa in the cell Ca) to the contention area Aa, and further performs handover from the cell Cc to the cell Cb in response to the user moving from the contention area Aa to the cell Cb (an area other than the contention area Aa in the cell Cb).

As a result, for example, the communication control device 3 can perform load balancing among the base station devices 1.

However, in the load balancing as illustrated in FIG. 3, for example, a load state in each base station device 1 is used as a balancing determination criterion. Therefore, in the load balancing as illustrated in FIG. 3, for example, communication quality in the terminal device 2 may be degraded.

Therefore, for example, the communication control device 3 in the present embodiment receives quality information (hereinafter, also simply referred to as quality information) indicating communication quality of each of a plurality of adjacent cells C adjacent to a process target cell C (hereinafter, also referred to as a target cell C or a specific cell C) and load information indicating a communication load (hereinafter, also simply referred to as load information). Then, for example, the communication control device 3 in the present embodiment calculates a reference value (hereinafter, also simply referred to as a reference value) indicating an upper limit value of the load information in which the quality information in each adjacent cell C satisfies a condition (hereinafter, also referred to as a first condition) for each of the plurality of adjacent cells C on the basis of the quality information and the load information corresponding to each adjacent cell C. For example, the first condition is that a value indicated by the quality information is not equal to or less than a predetermined threshold.

Subsequently, for example, the communication control device 3 in the present embodiment specifies one or more adjacent cells C whose load information at a predetermined timing is equal to or less than the reference value among the plurality of adjacent cells C (hereinafter, also simply referred to as one or more adjacent cells C), and specifies any adjacent cell C among the one or more adjacent cells C as a cell C on which the terminal device 2 located in a target cell C performs handover at a predetermined timing (hereinafter, also referred to as a first cell C or an HO destination cell C) on the basis of quality information corresponding to the specified one or more adjacent cells C. For example, the predetermined timing is a timing after the reference value is calculated. Thereafter, for example, the communication control device 3 in the present embodiment transmits information indicating the specified HO destination cell C to the base station device 1 corresponding to the target cell C.

That is, for example, the communication control device 3 in the present embodiment selects an adjacent cell C (HO destination cell C) of a handover destination of the terminal device 2 in the contention area A from adjacent cells C that can be determined to be able to maintain minimum required communication quality.

As a result, for example, the communication control device 3 in the present embodiment can perform load balancing among the base station devices 1 while suppressing quality degradation in the terminal device 2.

### Hardware Configuration of Wireless Communication System

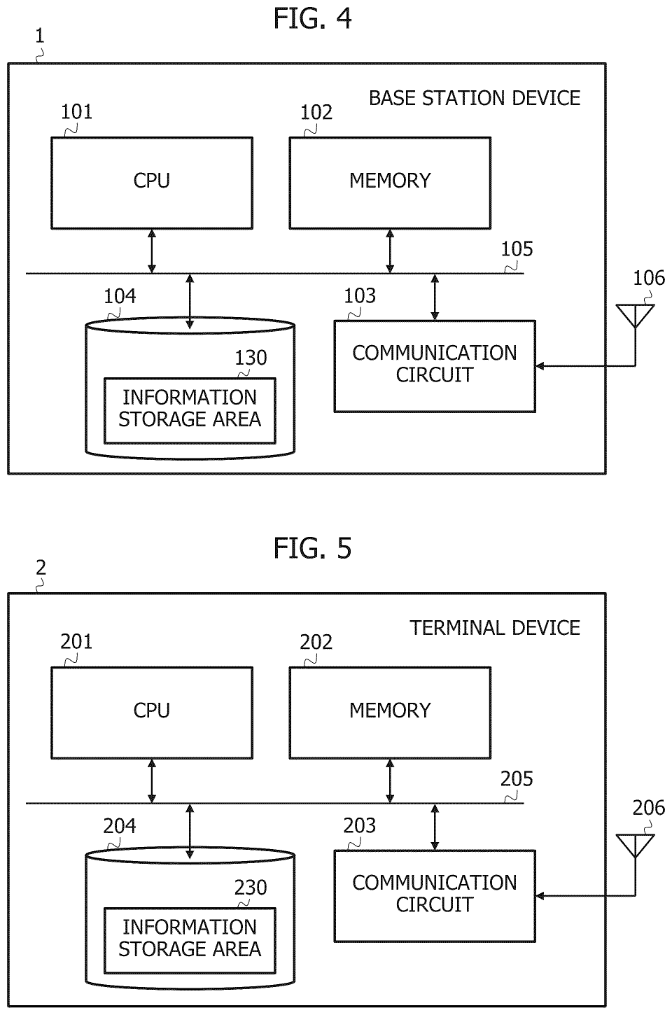

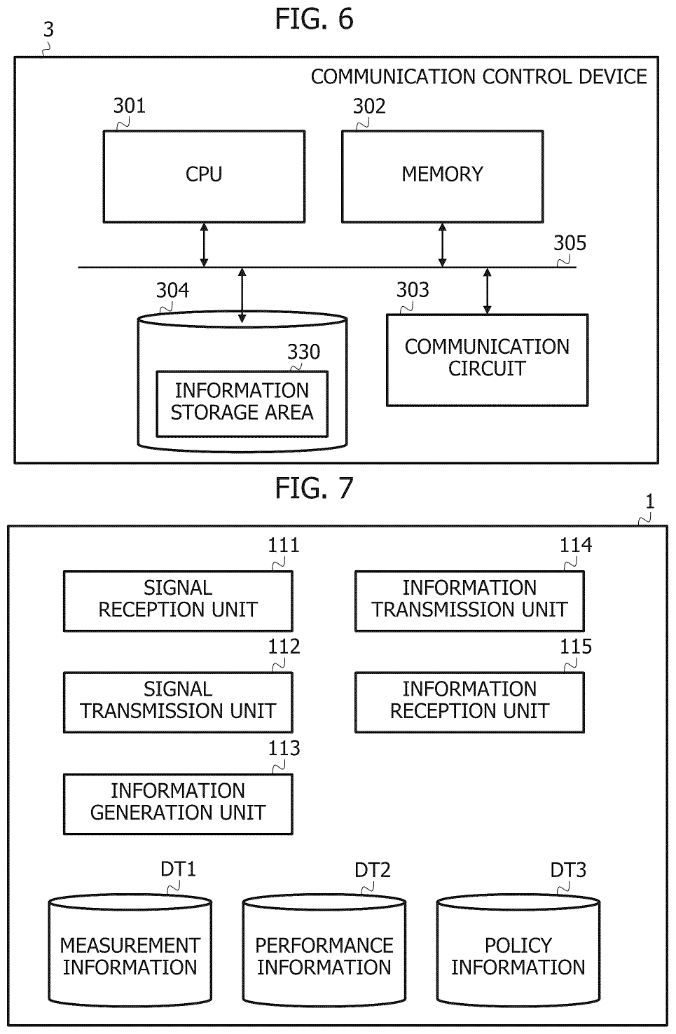

Next, a hardware configuration of the wireless communication system 10 will be described. FIG. 4 is a diagram for explaining a hardware configuration of the base station device 1. FIG. 5 is a diagram for explaining a hardware configuration of the terminal device 2. FIG. 6 is a diagram for explaining a hardware configuration of the communication control device 3.

First, a hardware configuration of the base station device 1 will be described. As illustrated in FIG. 4, for example, the base station device 1 includes a central processing unit (CPU) 101 that is a processor, a memory 102, a communication circuit 103, and a storage device 104. The units are connected to one another via a bus 105.

For example, the storage device 104 has a program storage area (not illustrated) for storing a program (not illustrated) for performing communication control process. In addition, for example, the storage device 104 includes a storage unit 130 (hereinafter, also referred to as an information storage area 130) that stores information used when communication control process is performed. Note that, for example, the storage device 104 may be a hard disk drive (HDD) or a solid state drive (SSD).

For example, the CPU 101 executes a program loaded from the storage device 104 into the memory 102 to perform communication control process.

For example, the communication circuit 103 has a circuit that performs communication by performing wireless connection with the terminal device 2 via an antenna 106. In addition, for example, the communication circuit 103 has a circuit that performs communication by performing wired connection with the communication control device 3.

Next, a hardware configuration of the terminal device 2 will be described. As illustrated in FIG. 5, for example, the terminal device 2 includes a CPU 201 that is a processor, a memory 202, a communication circuit 203, and a storage device 204. The units are connected to one another via a bus 205.

For example, the storage device 204 has a program storage area (not illustrated) for storing a program 210 for performing communication control process. In addition, for example, the storage device 204 includes a storage unit 230 (hereinafter, also referred to as an information storage area 230) that stores information used when communication control process is performed. Note that, for example, the storage device 204 may be an HDD or an SSD.

For example, the CPU 201 executes the program 210 loaded from the storage device 204 into the memory 202 to perform communication control process.

For example, the communication circuit 203 has a circuit that performs communication by performing wireless connection with the base station device 1 via an antenna 206.

Next, a hardware configuration of the communication control device 3 will be described. As illustrated in FIG. 6, for example, the communication control device 3 includes a central processing unit (CPU) 301 that is a processor, a memory 302, a communication circuit 303, and a storage device 304. The units are connected to one another via a bus 305.

For example, the storage device 304 has a program storage area (not illustrated) for storing a program (not illustrated) for performing communication control process. In addition, for example, the storage device 304 includes a storage unit 330 (hereinafter, also referred to as an information storage area 330) that stores information used when communication control process is performed. Note that, for example, the storage device 304 may be an HDD or an SSD.

For example, the CPU 301 executes a program loaded from the storage device 304 into the memory 302 to perform communication control process.

For example, the communication circuit 303 has a circuit that performs communication by performing wired connection with the base station device 1.

### Functions of Communication System in First Embodiment

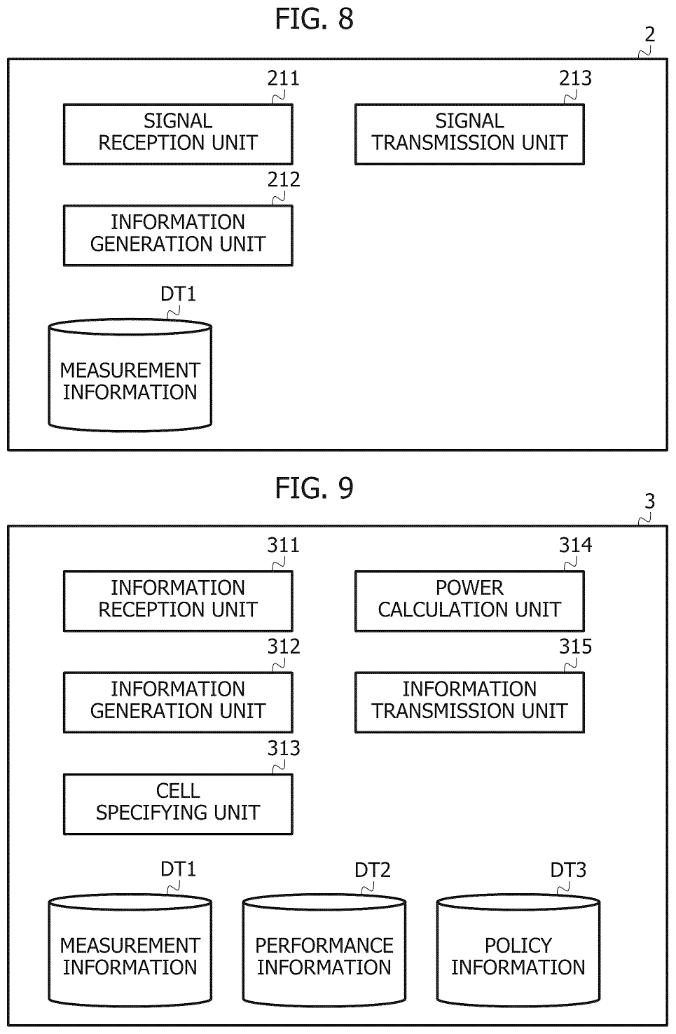

Next, functions of the wireless communication system 10 in the first embodiment will be described. FIG. 7 is a diagram for explaining functions of the base station device 1 in the first embodiment. FIG. 8 is a diagram for explaining functions of the terminal device 2 in the first embodiment. FIG. 9 is a diagram for explaining functions of the communication control device 3 in the first embodiment.

### Functions of base station device

First, functions of the base station device 1 will be described.

As illustrated in FIG. 7, for example, the base station device 1 implements various functions including a signal reception unit 111, a signal transmission unit 112, an information generation unit 113, an information transmission unit 114, and an information reception unit 115 by organic cooperation between hardware such as the CPU 101 and the memory 102, and a program.

For example, the signal reception unit 111 receives a signal (hereinafter, also referred to as an uplink signal) transmitted from the terminal device 2 via the antenna 106. For example, the uplink signal includes an uplink control signal and an uplink data signal. Then, for example, the uplink control signal is transmitted by a physical uplink control channel (PUCCH). For example, the uplink data signal is transmitted by a physical uplink shared channel (PUSCH).

Specifically, for example, the signal reception unit 111 receives a signal (uplink control signal) including measurement information DT1 transmitted from the terminal device 2. For example, the measurement information DT1 is information indicating a measurement result such as reception quality (reference signal received power (RSRP)) of a signal in the terminal device 2. For example, the measurement information DT1 is also called Measurement Report. Then, as illustrated in FIG. 7, for example, the signal reception unit 111 stores the measurement information DT1 included in the received signal in the information storage area 130.

For example, the signal transmission unit 112 transmits a signal (downlink signal) to the terminal device 2 via the antenna 106. For example, the downlink signal includes a downlink control signal and a downlink data signal. Then, for example, the downlink control signal is transmitted by a physical downlink control channel (PDCCH). For example, the downlink data signal is transmitted by a physical downlink shared channel (PDSCH).

For example, the information generation unit 113 generates performance information DT2 including quality information and load information in a cell C corresponding to its own device (base station device 1). For example, the performance information DT2 is also called PerforMance (PM) data. Specifically, for example, the information generation unit 113 generates the performance information DT2 including the quality information and the load information in a time period after the performance information DT2 is generated last time every predetermined time. Then, as illustrated in FIG. 7, for example, the information generation unit 113 stores the generated performance information DT2 in the information storage area 130.

For example, the information transmission unit 114 transmits the measurement information DT1 received by the signal reception unit 111 to the communication control device 3. In addition, for example, the information transmission unit 114 transmits the performance information DT2 generated by the information generation unit 113 to the communication control device 3.

For example, the information reception unit 115 receives policy information DT3 transmitted from the communication control device 3. For example, the policy information DT3 is information including a policy used when a handover destination cell C (HO destination cell C) of the terminal device 2 located in a cell C corresponding to its own device (base station device 1) is determined. Then, for example, the information reception unit 115 stores the received policy information DT3 in the information storage area 130.

### Functions of Terminal Device

Next, functions of the terminal device 2 will be described.

As illustrated in FIG. 8, for example, the terminal device 2 implements various functions including a signal reception unit 211, an information generation unit 212, and a signal transmission unit 213 by organic cooperation between hardware such as the CPU 201 and the memory 202, and the program 210.

For example, the signal reception unit 211 receives a downlink signal transmitted from the base station device 1 via the antenna 206.

For example, the information generation unit 212 generates the measurement information DT1 in its own device (terminal device 2). Specifically, for example, the information generation unit 113 generates the measurement information DT1 in a time period after the measurement information DT1 is generated last time every predetermined time. Then, for example, the information generation unit 212 stores the generated measurement information DT1 in the information storage area 230.

For example, the signal transmission unit 213 transmits an uplink signal to the base station device 1 via the antenna 206.

Specifically, for example, the signal transmission unit 213 transmits a signal (uplink control signal) including the measurement information DT1 generated by the information generation unit 212 to the base station device 1.

### Functions of Communication Control Device

Next, functions of the communication control device 3 will be described.

As illustrated in FIG. 9, for example, the base station device 1 implements various functions including an information reception unit 311, an information generation unit 312 (hereinafter, also referred to as a reference calculation unit 312), a cell specifying unit 313, a power calculation unit 314, and an information transmission unit 315 by organic cooperation between hardware such as the CPU 301 and the memory 302, and a program.

Note that a case where various functions including the information reception unit 311, the information generation unit 312, the cell specifying unit 313, the power calculation unit 314, and the information transmission unit 315 are implemented in one communication control device 3 will be described below, but the present invention is not limited thereto. Specifically, for example, the various functions including the information reception unit 311, the information generation unit 312, the cell specifying unit 313, the power calculation unit 314, and the information transmission unit 315 may be functions implemented in a distributed manner in a plurality of communication control devices 3.

For example, the information reception unit 311 receives the performance information DT2 from the respective plurality of base station devices 1 corresponding to the plurality of adjacent cells C. Then, as illustrated in FIG. 9, for example, the information reception unit 311 stores each piece of the received performance information DT2 in the information storage area 330.

For example, the information generation unit 312 calculates a reference value indicating an upper limit value of load information in which quality information in each cell C satisfies the first condition for each of the plurality of adjacent cells C on the basis of quality information and load information included in the performance information DT2 (performance information DT2 stored in the information storage area 130) corresponding to each adjacent cell C. Then, for example, the information generation unit 312 generates the policy information DT3 including the calculated reference value. Thereafter, the information generation unit 312 stores the generated policy information DT3 in the information storage area 330.

Note that, for example, the quality information may include information indicating a quality state of communication in the terminal device 2 located in each cell C or information (value) calculated using each piece of information indicating a quality state of communication in the terminal device 2 located in each cell C among pieces of information included in the performance information DT2. Specifically, for example, the quality information may be an establishment success ratio of radio resource control (RRC) connection in each cell C or a handover success ratio to each cell C. In addition, for example, the quality information may include pieces of information included in the measurement information DT1.

In addition, for example, the load information may include information indicating a load state in each cell C or information (value) generated from information indicating a load state in each cell C among pieces of information included in the performance information DT2. Specifically, for example, the load information may be an RRC connection ratio in each cell C or a cell throughput ratio in each cell C.

For example, the cell specifying unit 313 specifies one or more adjacent cells C whose load information at a predetermined timing is equal to or less than a reference value among the plurality of adjacent cells C, and specifies any adjacent cell C among the one or more adjacent cells C as a cell C on which the terminal device 2 located in a target cell C performs handover at a predetermined timing (HO destination cell C) on the basis of respective pieces of quality information corresponding to the specified one or more adjacent cells C.

For example, the power calculation unit 314 calculates transmission power to the terminal device 2 in the HO destination cell C according to the quality information in the HO destination cell C specified by the cell specifying unit 313.

For example, the information transmission unit 315 transmits policy information DT3 generated by the information generation unit 312 to the base station device 1 corresponding to the target cell C. In addition, for example, the information transmission unit 315 transmits information indicating the HO destination cell C specified by cell specifying unit 313 (hereinafter, also referred to as cell information) to the base station device 1 corresponding to the target cell C. In addition, for example, the information transmission unit 315 transmits information indicating the transmission power calculated by the power calculation unit 314 to the base station device 1 corresponding to the target cell C.

Note that, hereinafter, a case where a reference value indicating an upper limit value of load information in which quality information in each cell C satisfies the first condition is calculated, and one or more adjacent cells C in which load information at a predetermined timing is equal to or less than the reference value are specified will be described, but the present invention is not limited thereto. Specifically, for example, the information generation unit 312 may calculate, for each of the plurality of adjacent cells C, another reference value indicating a lower limit value of the quality information in which the quality information in each cell C satisfies the first condition (hereinafter, also simply referred to as another reference value). Then, for example, the cell specifying unit 313 may specify one or more adjacent cells C whose quality information at a predetermined timing is equal to or more than another reference value.

### Sequence Chart of Communication Control Process in First Embodiment

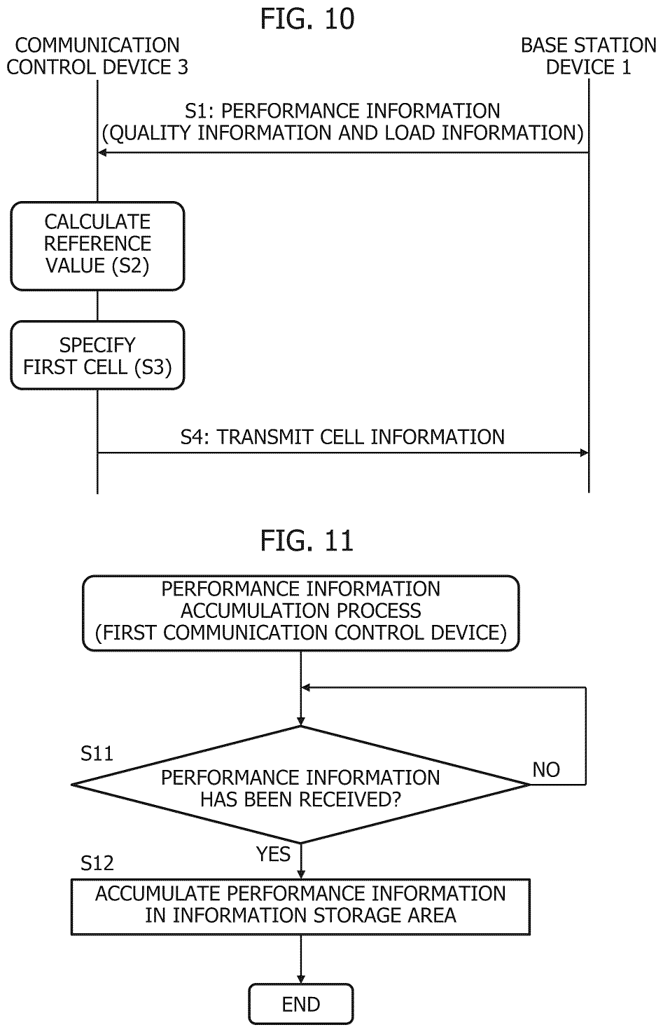

Next, a sequence chart of communication control process in the first embodiment will be described. FIG. 10 is a sequence chart of communication control process in the first embodiment.

As illustrated in FIG. 10, for example, the communication control device 3 receives performance information DT2 for each of a plurality of adjacent cells C adjacent to a target cell C (S1).

Then, for example, the communication control device 3 calculates a reference value corresponding to each of the plurality of adjacent cells C on the basis of quality information and load information included in the performance information DT2 received in S1 (S2).

Subsequently, for example, the communication control device 3 specifies one or more adjacent cells C whose load information at a predetermined timing is equal to or less than the reference value calculated in S2 among the plurality of adjacent cells C, and specifies any cell C among the one or more adjacent cells C as an HO destination cell C on which the terminal device 2 located in a target cell C performs handover at a predetermined timing on the basis of respective pieces of quality information corresponding to the specified one or more adjacent cells C (S3).

Thereafter, for example, the communication control device 3 transmits information indicating the HO destination cell C specified in S3 (cell information) to the base station device 1 corresponding to the target cell C (S4).

That is, for example, the communication control device 3 in the present embodiment selects an adjacent cell C (HO destination cell C) of a handover destination of the terminal device 2 in a contention area A from adjacent cells C that can be determined to be able to maintain minimum required communication quality.

As a result, for example, the communication control device 3 in the present embodiment can perform load balancing among the base station devices 1 while suppressing quality degradation in the terminal device 2.

### Details of Communication Control Process in First Embodiment

Next, details of the communication control process in the first embodiment will be described. FIGS. 11 to 19 are flowcharts for explaining details of the communication control process in the first embodiment. FIGS. 20 to 28 are diagrams for explaining details of the communication control process in the first embodiment.

Note that a case where the wireless communication system 10 includes two communication control devices 3 will be described. Specifically, description will be given below assuming that a first communication control device 3 (also referred to as a communication control device 3a or a first communication control device 3a) includes the information reception unit 311 (hereinafter, also referred to as an information reception unit 311a), the information generation unit 312, and the information transmission unit 315 (hereinafter, also referred to as an information transmission unit 315a). In addition, description will be given below assuming that a second communication control device 3 (also referred to as a communication control device 3b or a second communication control device 3b) includes the information reception unit 311 (hereinafter, also referred to as an information reception unit 311b), the cell specifying unit 313, the power calculation unit 314, and the information transmission unit 315 (hereinafter, also referred to as an information transmission unit 315b). In addition, the information storage area 330 included in the communication control device 3a will also be referred to as an information storage area 330a, and the information storage area 330 included in the communication control device 3b will also be referred to as an information storage area 330b.

### Performance Information Accumulation Process in First Communication Control Device

First, process of accumulating the performance information DT2 (hereinafter, also referred to as performance information accumulation process) among pieces of communication control process in the communication control device 3a will be described. FIG. 11 is a flowchart for explaining the performance information accumulation process.

As illustrated in FIG. 11, for example, the information reception unit 311a waits until the information reception unit 311a receives the performance information DT2 transmitted from the base station device 1 (NO in S11).

Specifically, for example, the information reception unit 311a waits until the base station device 1 transmits the performance information DT2 by using an O1 interface defined in third generation partnership project (3GPP) (registered trademark).

Then, if the information reception unit 311a receives the performance information DT2 (YES in S11), for example, the information reception unit 311a stores the received performance information DT2 in the information storage area 330a (S12). A specific example of the performance information DT2 will be described below.

### Specific Example of Performance Information

FIG. 20 is a diagram for explaining a specific example of the performance information DT2.

As illustrated in FIG. 20, for example, “DL Total PRB Usage” or “UL Total PRB Usage” defined in 3GPP TS28.552 is set as “PRB usage ratio” in the performance information DT2. In addition, for example, “mean number of RRC connections” defined in the 3GPP TS28.552 is set as “number of connected users” in the performance information DT2.

In addition, for example, “average delay DL air-interface” or “average delay UL on over the air-interface” defined in 3GPP TS28.552 is set as “average delay” in the performance information DT2. In addition, for example, “average DL UE throughput in gNB” or “average UL UE throughput in gNB” defined in 3GPP TS28.552 is set as “average throughput” in the performance information DT2. Description of other information included in FIG. 20 is omitted.

### Policy Generation Process in First Communication Control Device

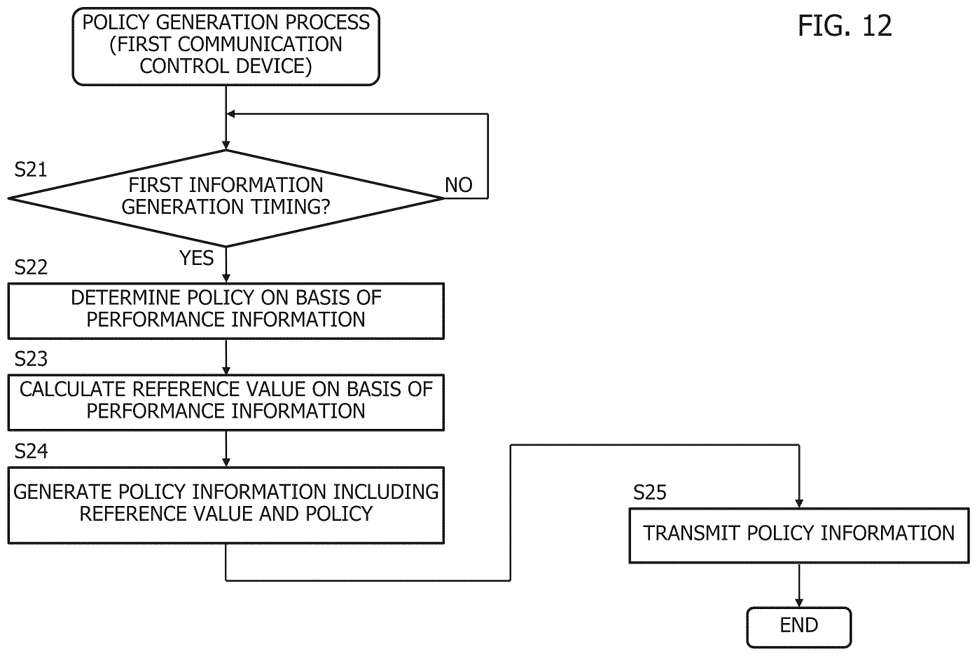

Next, process of generating the policy information DT3 (hereinafter, also referred to as policy generation process) among pieces of communication control process in the communication control device 3a will be described. FIG. 12 is a flowchart for explaining the policy generation process.

As illustrated in FIG. 12, for example, the information generation unit 312 waits until a first information generation timing is reached (NO in S21). For example, the first information generation timing is a periodic timing every ten minutes.

Then, if the first information generation timing is reached (YES in S21), for example, the information generation unit 312 determines a policy in each cell C on the basis of the performance information DT2 (performance information DT2 stored in the information storage area 330a) corresponding to each cell C for each of a plurality of cells C (hereinafter, also simply referred to as a plurality of cells C) controlled by the communication control device 3a (S22).

Specifically, in S22, for example, the policy in each cell C is determined to be either “quality priority” indicating that ensuring of communication quality in the terminal device 2 located in each cell C is prioritized over load balancing in the base station device 1 corresponding to each cell C or “balancing priority” indicating that load balancing in the base station device 1 corresponding to each cell C is prioritized over ensuring of communication quality in the terminal device 2 located in each cell C. Details of S22 will be described below.

### Details of S22

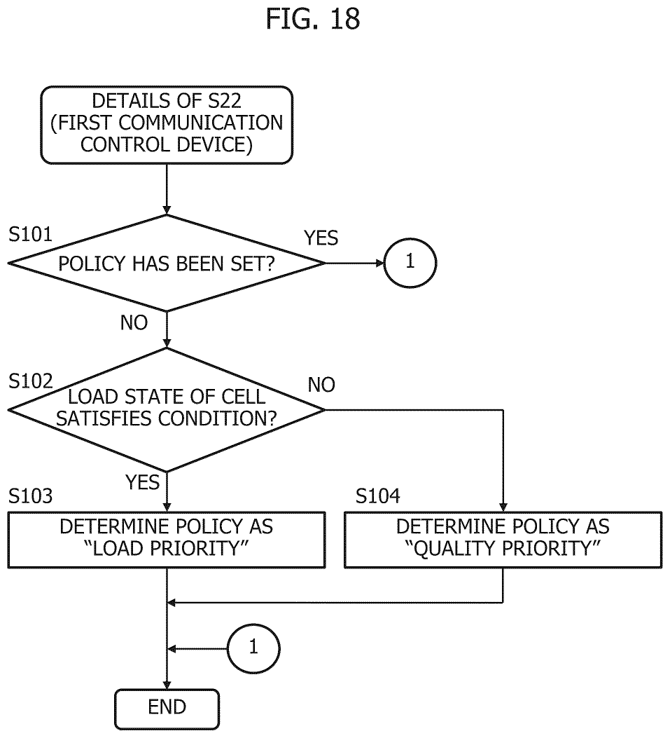

FIG. 18 is a flowchart for explaining details of S22. A case where S22 for the cell Ca is performed will be described below.

As illustrated in FIG. 18, for example, the information generation unit 312 determines whether or not a policy corresponding to the cell Ca is set in advance by an administrator of the wireless communication system 100 (hereinafter, also simply referred to as an administrator) (S101).

As a result, if the information generation unit 312 determines that the policy is set in advance by the administrator (YES in S101), for example, the information generation unit 312 ends S22. That is, in this case, for example, the information generation unit 312 uses a policy set in advance by the administrator as a policy corresponding to the cell Ca after S23.

On the other hand, if the information generation unit 312 determines that the policy is not set in advance by the administrator (NO in S101), for example, the information generation unit 312 determines whether or not a load state of the cell Ca satisfies a predetermined condition (hereinafter, also simply referred to as a predetermined condition) on the basis of the performance information DT2 corresponding to the cell Ca (the performance information DT2 stored in the information storage area 330 a) (S102).

Specifically, for example, if a value (hereinafter, also referred to as a first value) set to the “PRB usage ratio” included in the performance information DT2 is equal to or more than a predetermined threshold (hereinafter, also referred to as a first threshold), the information generation unit 312 determines that the load state of the cell Ca satisfies the predetermined condition.

In addition, for example, if a value (hereinafter, also referred to as a second value) calculated by dividing a value set to “the number of connected users” included in the performance information DT2 by the maximum accommodation number (predetermined value) of the terminal device 2 in the cell Ca is equal to or more than a predetermined threshold (hereinafter, also referred to as a second threshold), the information generation unit 312 determines that the load state of the cell Ca satisfies the predetermined condition.

Note that, for example, the information generation unit 312 may determine that the load state of the cell Ca satisfies the predetermined condition if the first value is equal to or more than the first threshold and the second value is equal to or more than the second threshold.

Then, if the information generation unit 312 determines that the load state of the cell Ca satisfies the predetermined condition (YES in S102), for example, the information generation unit 312 determines the policy corresponding to the cell Ca as “load priority” (S103).

That is, in this case, for example, the information generation unit 312 determines that the cell Ca is in a high load state, and determines that priority is given to load balancing in the base station device 1 (base station device 1a) corresponding to the cell Ca.

On the other hand, if the information generation unit 312 determines that the load state of the cell Ca does not satisfy the condition (NO in S102), for example, the information generation unit 312 determines the policy corresponding to the cell Ca as “quality priority” (S104).

That is, in this case, for example, the information generation unit 312 determines that the cell Ca is in a low load state, and determines that priority is given to ensuring of communication quality in the terminal device 2 located in the cell Ca.

Returning to FIG. 12, for example, the information generation unit 312 calculates a reference value in each cell C on the basis of the performance information DT2 corresponding to each cell C for each of the plurality of cells C (S23). Details of S23 will be described below.

### Details of S23

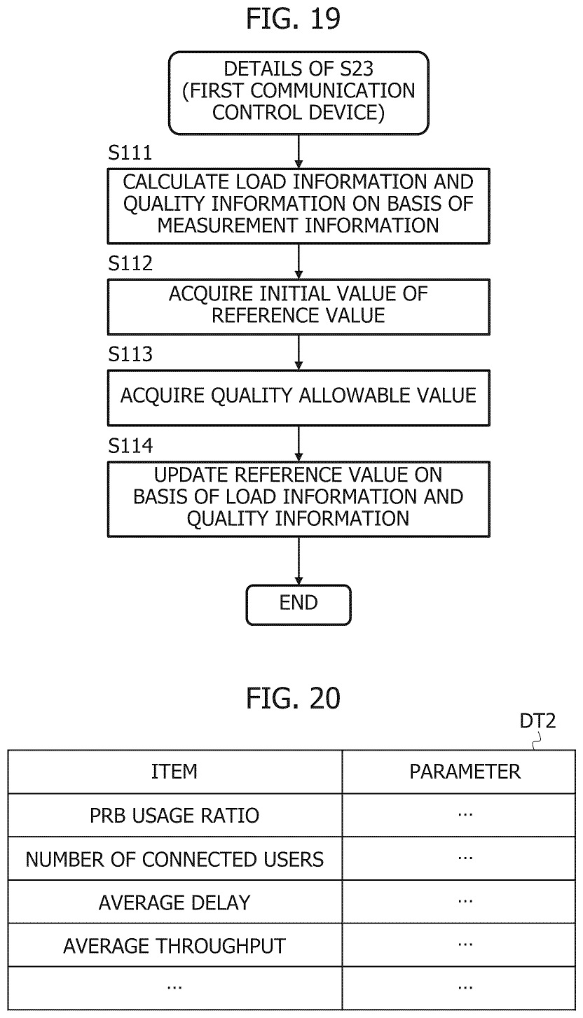

FIG. 19 is a flowchart for explaining details of S23. A case where S23 for the cell Ca is performed will be described below.

For example, the information generation unit 312 generates load information and quality information from each piece of information included in each piece of the performance information DT2 for each piece of the performance information DT2 (performance information DT2 stored in the information storage area 330a) corresponding to the cell Ca (S111).

Specifically, for example, the information generation unit 312 calculates a value (for example, an RRC connection ratio or a cell throughput ratio in the cell Ca) calculated using each piece of information indicating a load state in the cell Ca among pieces of information included in the performance information DT2 corresponding to the cell Ca as load information (hereinafter, also referred to as a cell load ratio). More specifically, for example, the information generation unit 312 calculates an average value or a maximum value of values calculated using each piece of information indicating the load state in the cell Ca as the load information.

In addition, for example, the information generation unit 312 calculates a value (for example, an RRC connection establishment success ratio or a handover success ratio in the cell Ca) calculated using each piece of information indicating a quality state of communication in the terminal device 2 located in the cell Ca among pieces of information included in the performance information DT2 corresponding to the cell Ca as quality information (hereinafter, also referred to as a cell quality ratio). More specifically, for example, the information generation unit 312 calculates an average value or a maximum value of values calculated using each piece of information indicating a quality state of communication in the terminal device 2 located in the cell Ca as the quality information.

Then, for example, the information generation unit 312 acquires an initial value (not illustrated) of the reference value stored in the information storage area 330a (S112). For example, the initial value of the reference value may be stored in advance in the information storage area 330a by the administrator.

In addition, for example, the information generation unit 312 acquires a quality allowable value (not illustrated) stored in the information storage area 330a (S113). For example, the quality allowable value may be a minimum allowable value of the quality information in the terminal device 2, and may be stored in the information storage area 330a in advance by the administrator.

Thereafter, for example, the information generation unit 312 calculates a reference value (updated value) from the initial value of the reference value acquired in S112 and the minimum allowable value acquired in S113 by using an approximate straight line of points corresponding to the quality information and the load information calculated in S111 (S114).

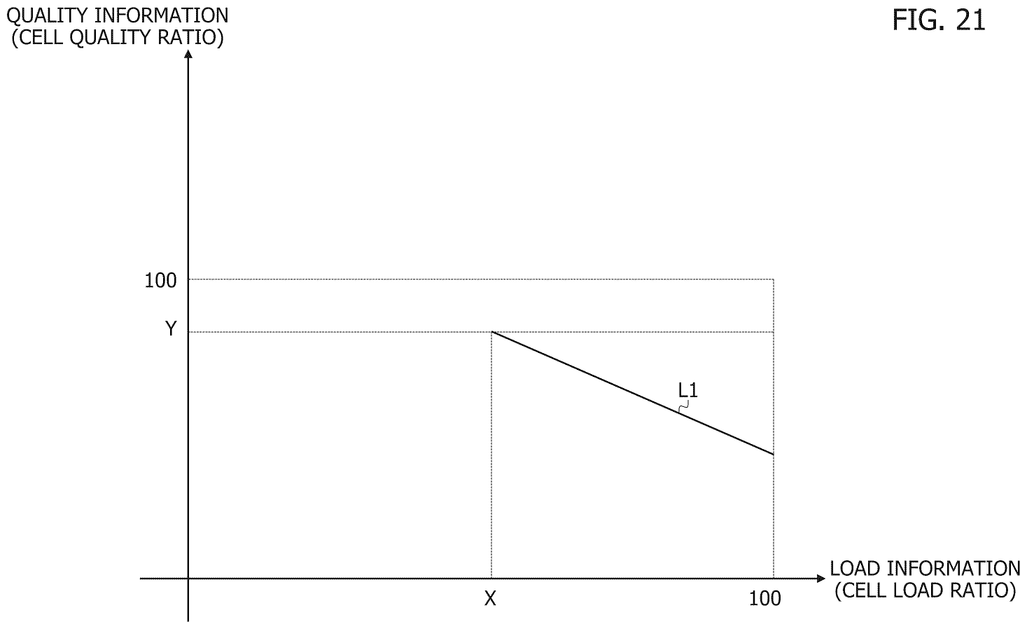

Specifically, as illustrated in FIG. 21, for example, the information generation unit 312 plots a point at which the quality information is less than the quality allowable value (Y in FIG. 21) among points corresponding to the quality information and the load information calculated in S111 on a two-dimensional plane in which the X axis and the Y axis correspond to the load information and the quality information, respectively. Then, for example, the information generation unit 312 calculates an approximate straight line L1 of the plotted points. Thereafter, for example, the information generation unit 312 calculates a reference value (X in FIG. 21) corresponding to the quality allowable value (Y in FIG. 21) on the calculated approximate straight line L1.

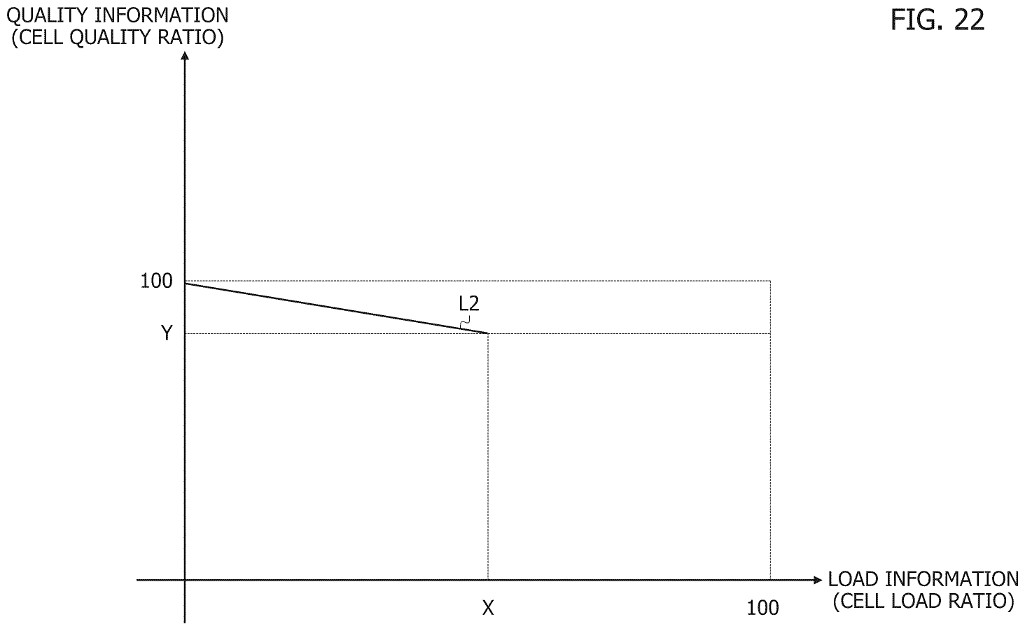

In addition, as illustrated in FIG. 22, the information generation unit 312 plots a point at which the quality information is equal to or more than the quality allowable value (Y in FIG. 22) among points corresponding to the quality information and the load information calculated in S111 on the two-dimensional plane in which the X axis and the Y axis correspond to the load information and the quality information, respectively. Then, for example, the information generation unit 312 calculates an approximate straight line L2 of the plotted points. Thereafter, for example, the information generation unit 312 calculates a reference value (X in FIG. 22) corresponding to the quality allowable value (Y in FIG. 22) on the calculated approximate straight line L2.

Note that, for example, the information generation unit 312 may calculate a reference value by preferentially using an approximate straight line having a large absolute value of slope (the approximate straight line L1 in the examples illustrated in FIGS. 21 and 22) out of the approximate straight line L1 and the approximate straight line L2.

In addition, for example, when the reference value calculated by using the approximate straight line L1 or the approximate straight line L2 is less than the initial value of the reference value, the information generation unit 312 may determine the initial value of the reference value as the reference value.

Returning to FIG. 12, for example, the information generation unit 312 generates the policy information DT3 including the policy calculated in S22 and the reference value calculated in S23 for each of the plurality of cells C (S24).

Then, for example, the information transmission unit 315 transmits the policy information DT3 generated in S24 to the base station device 1 corresponding to each cell C for each of the plurality of cells C (S25). A specific example of the policy information DT3 will be described below.

### Specific Example of Policy Information

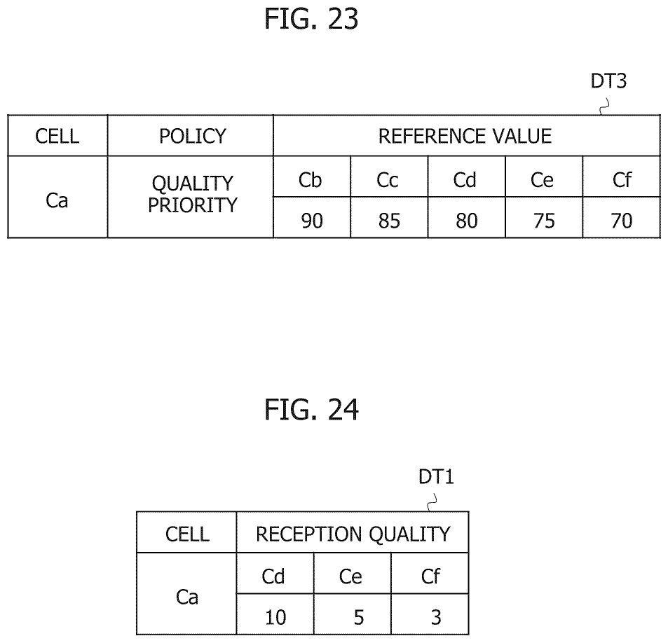

FIG. 23 is a diagram for explaining a specific example of the policy information DT3. Specifically, FIG. 23 is a diagram for explaining a specific example of the policy information DT3 generated for the cell Ca. Note that, hereinafter, the cell Ca, the cell Cb, the cell Cc, the cell Cd, the cell Ce, and the cell Cf described with reference to FIG. 3 are also simply referred to as Ca, Cb, Cc, Cd, Ce, and Cf, respectively.

As illustrated in FIG. 23, for example, the policy information DT3 has “cell” in which information indicating each cell C is set and “policy” in which a policy used when a handover destination cell C (HO destination cell C) of the terminal device 2 located in each cell C is determined is set as items. In addition, as illustrated in FIG. 23, for example, the policy information DT3 has “reference value” in which a reference value corresponding to each adjacent cell C in each cell C is set as an item.

Specifically, for example, in the policy information DT3 illustrated in FIG. 23, “Ca” is set as “cell”, “quality priority” is set as “policy”, “90(%)” is set as “reference value” corresponding to “Cb”, “85(%)” is set as “reference value” corresponding to “Cc”, “80(%)” is set as “reference value” corresponding to “Cd”, “75(%)” is set as “reference value” corresponding to “Ce”, and “70(%)” is set as “reference value” corresponding to “Cf”.

### Policy Update Process in Second Communication Control Device

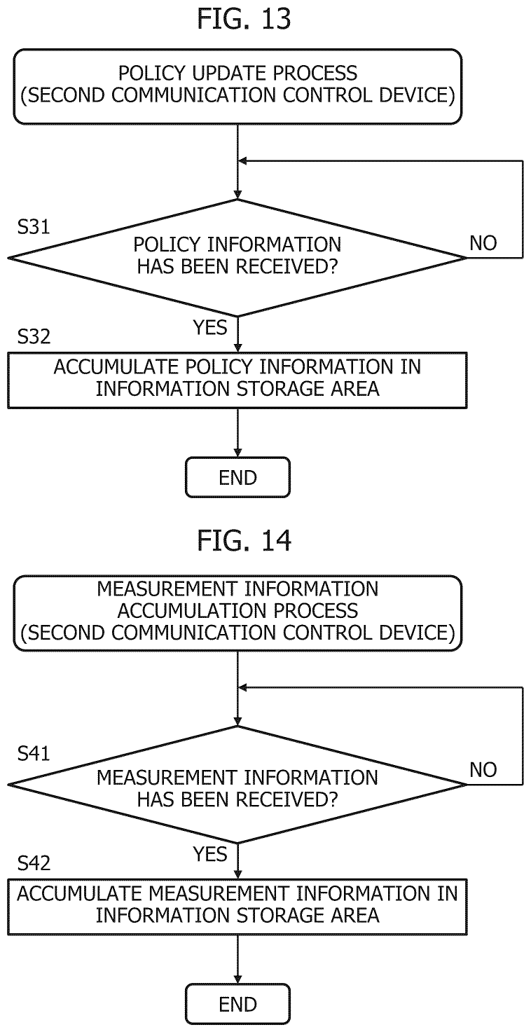

Next, process of updating the policy information DT3 (hereinafter, also referred to as policy update process) among pieces of communication control process in the communication control device 3b will be described. FIG. 13 is a flowchart for explaining the policy update process.

As illustrated in FIG. 13, for example, the information reception unit 311b waits until the information reception unit 311b receives the policy information DT3 transmitted from the communication control device 3a (NO in S31).

Specifically, for example, the information reception unit 311b waits until the communication control device 3a transmits the policy information DT3 by using an A1 interface defined in 3GPP.

Then, if the information reception unit 311b receives the policy information DT3 (YES in S31), for example, the information reception unit 311b stores the received performance information DT2 in the information storage area 330b (S32).

### Measurement Information Accumulation Process in second Communication Control Device

Next, process of accumulating the measurement information DT1 (hereinafter, also referred to as measurement information accumulation process) among pieces of communication control process in the communication control device 3b will be described. FIG. 14 is a flowchart for explaining the measurement information accumulation process.

As illustrated in FIG. 14, for example, the information reception unit 311b waits until the information reception unit 311b receives the measurement information DT1 transmitted from the base station device 1 (the measurement information DT1 transmitted from the terminal device 2 via the base station device 1) (NO in S41).

Specifically, for example, the information reception unit 311b waits until the base station device 1 transmits the measurement information DT1 by using an E2 interface defined in 3GPP.

Then, if the information reception unit 311b receives the measurement information DT1 transmitted from the base station device 1 (YES in S41), for example, the information reception unit 311b stores the received measurement information DT1 in the information storage area 330b (S42). A specific example of the measurement information DT1 will be described below.

### Specific Example of Measurement Information

FIG. 24 is a diagram for explaining a specific example of the measurement information DT1. Specifically, FIG. 24 is a diagram for explaining a specific example of the measurement information DT1 transmitted from the base station device 1 corresponding to the cell Ca.

As illustrated in FIG. 24, for example, the measurement information DT1 has “cell” in which information indicating each cell C is set and “reception quality” in which reception quality of a signal transmitted from the base station device 1 corresponding to the adjacent cell C in each cell C is set as items.

Specifically, in the measurement information DT1 illustrated in FIG. 24, for example, “Ca” is set as “cell”, “10 (dB)” is set as “reception quality” corresponding to “Cd”, “5 (dB)” is set as “reception quality” corresponding to “Ce”, and “3 (dB)” is set as “reception quality” corresponding to “Cf”.

That is, for example, it is indicated that the measurement information DT1 illustrated in FIG. 24 has been transmitted from the terminal device 2 located in the contention area Ac capable of receiving each of the signal transmitted from base station device 1 corresponding to the cell Ca, the signal transmitted from the base station device 1 corresponding to the cell Cd, the signal transmitted from the base station device 1 corresponding to the cell Ce, and the signal transmitted from the base station device 1 corresponding to the cell Cf. In other words, for example, the measurement information DT1 illustrated in FIG. 24 indicates that the cell Cd, the cell Ce, and the cell Cf exist as candidates for a handover destination of the terminal device 2 that has transmitted the measurement information DT1.

### Value Calculation Process in Second Communication Control Device

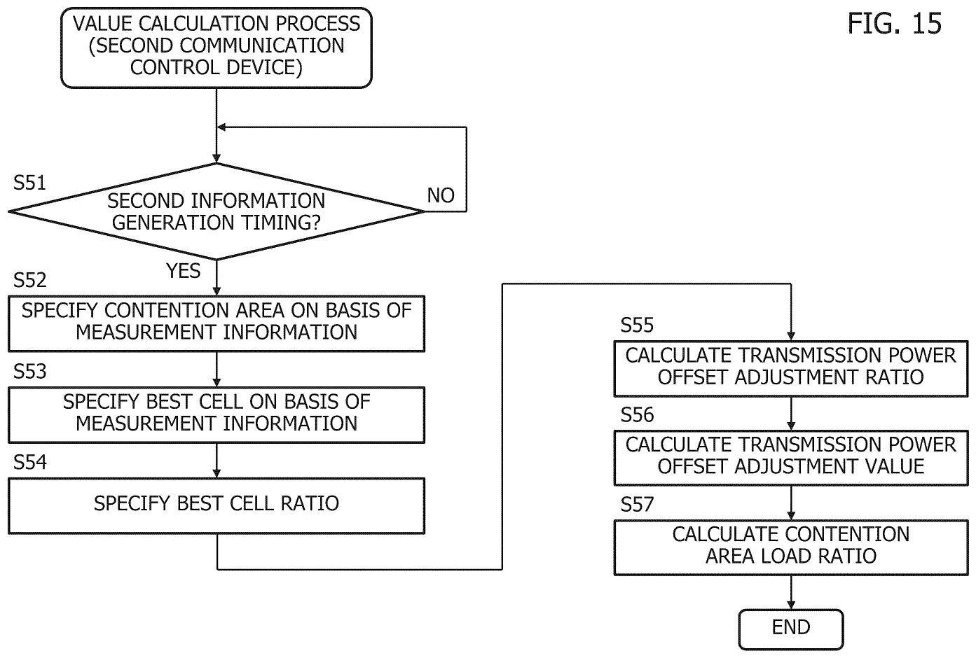

Next, process of calculating various values used to specify an HO destination cell C among pieces of communication control process in the communication control device 3b (hereinafter, also referred to as value calculation process) will be described. FIG. 15 is a flowchart for explaining the value calculation process.

As illustrated in FIG. 15, for example, the cell specifying unit 313 waits until a second information generation timing is reached (NO in S51). For example, the second information generation timing may be a timing at which the measurement information DT1 transmitted from the base station device 1 in S41 (the measurement information DT1 transmitted from the terminal device 2 via the base station device 1) is received.

Then, if the second information generation timing is reached (YES in S51), for example, the cell specifying unit 313 specifies the contention area A on the basis of the measurement information DT1 received in S41 (S52).

Specifically, the measurement information DT1 described with reference to FIG. 24 includes information on the cell Ca, the cell Cd, the cell Ce, and the cell Cf. Therefore, if the measurement information DT1 received in S41 is the measurement information DT1 described with reference to FIG. 24, for example, the cell specifying unit 313 specifies the contention area Ac.

Subsequently, for example, the cell specifying unit 313 specifies a cell C (hereinafter, also referred to as a best cell C) having the highest reception quality in the transmission source terminal device 2 of the measurement information DT1 received in S41 on the basis of the measurement information DT1 received in S41 (S53).

Specifically, for example, the measurement information DT1 described with reference to FIG. 24 indicates that the reception quality of the cell Cd is the highest among the cell Cd, the cell Ce, and the cell Cf. Therefore, if the measurement information DT1 received in S41 is the measurement information DT1 described with reference to FIG. 24, for example, the cell specifying unit 313 specifies the cell Cd as the best cell C.

Note that, for example, the cell specifying unit 313 may generate aggregation information DT4 (hereinafter, also referred to as aggregation information DT4a) including an aggregation result of a process result in S53. For example, the cell specifying unit 313 may store the generated aggregation information DT4a in the information storage area 330b. A specific example of the aggregation information DT4a will be described below.

### Specific Example (1) of Aggregation Information

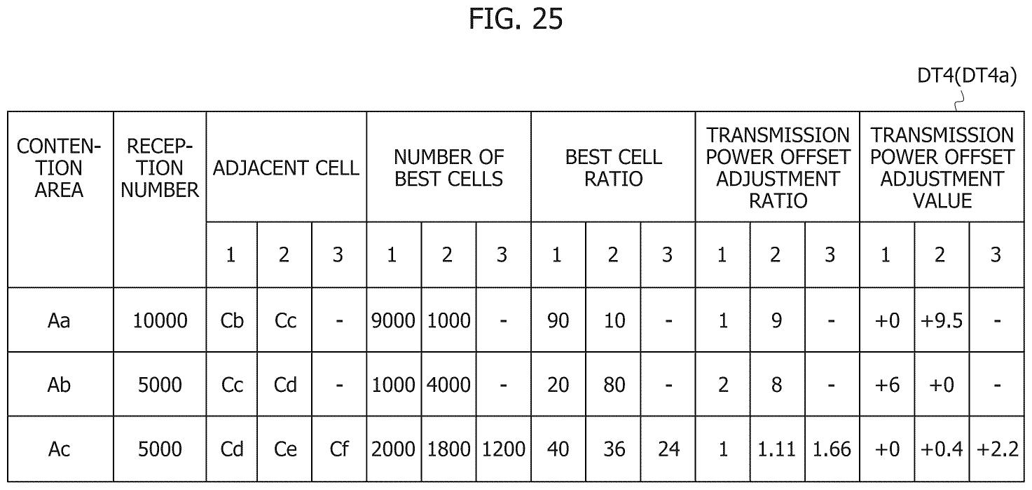

FIG. 25 is a diagram for explaining a specific example of the aggregation information DT4a. Specifically, FIG. 25 is a diagram for explaining a specific example of the aggregation information DT4a corresponding to the measurement information DT1 transmitted from the base station device 1 corresponding to the cell Ca. Hereinafter, the contention area Aa, the contention area Ab, and the contention area Ac described with reference to FIG. 3 are also simply referred to as Aa, Ab, and Ac, respectively.

For example, the aggregation information DT4a illustrated in FIG. 25 has “contention area” in which the contention area A specified in S52 is set and “reception number” indicating the number (reception number) of pieces of the measurement information DT1 transmitted from the terminal device 2 located in the contention area A specified in S52 as items. In addition, for example, the aggregation information DT4a illustrated in FIG. 25 has “adjacent cell” in which information indicating an adjacent cell C of the cell C in which the terminal device 2 is located among cells C forming the contention area A specified in S52 is set and “number of best cells” indicating the number of times each cell C is specified as the best cell C in S53 as items.

Specifically, in the information in the first row of the aggregation information DT4a illustrated in FIG. 25, for example, “Aa” is set as the “contention area”, “10,000” is set as the “reception number”, “Cb” and “Cc” are set as the “adjacent cell”, “9000” is set as the “number of best cells” corresponding to “Cb”, and “1000” is set as the “number of best cells” corresponding to “Cc”.

In addition, in the information in the second row of the aggregation information DT4a illustrated in FIG. 25, for example, “Ab” is set as the “contention area”, “5000” is set as the “reception number”, “Cc” and “Cd” are set as the “adjacent cell”, “1000” is set as the “number of best cells” corresponding to “Cc”, and “4000” is set as the “number of best cells” corresponding to “Cd”.

In addition, in the information in the third row of the aggregation information DT4a illustrated in FIG. 25, for example, “Ac” is set as the “contention area”, “5000” is set as the “reception number”, “Cd, “Ce”, and “Cf” are set as the “adjacent cell”, “2000” is set as the “number of best cells” corresponding to “Cd”, “1800” is set as the “number of best cells” corresponding to “Ce”, and “1200” is set as the “number of best cells” corresponding to “Cf”.

Returning to FIG. 15, for example, the cell specifying unit 313 calculates a best cell ratio for the contention area A specified in S52 (S54). For example, the best cell ratio is a ratio of the number of best cells corresponding to each of the adjacent cells C forming the contention area A to the total number of best cells in the contention area A.

Specifically, in the third row of the aggregation information DT4a illustrated in FIG. 25, for example, “2000” is set as the “number of best cells” corresponding to “Cd”, “1800” is set as the “number of best cells” corresponding to “Ce”, and “1200” is set as the “number of best cells” corresponding to “Cf”. In the third row of the aggregation information DT4a illustrated in FIG. 25, “5000” is set as the “reception number”. Therefore, in this case, for example, the cell specifying unit 313 specifies 40(%) calculated by dividing “2000” set to the “number of best cells” corresponding to “Cd” by“5000” set to the “reception number” as a best cell ratio corresponding to the cell Cd. In addition, in this case, for example, the cell specifying unit 313 specifies 36(%) calculated by dividing “1800” set to the “number of best cells” corresponding to “Ce” by“5000” set to the “reception number” as a best cell ratio corresponding to the cell Ce. Furthermore, in this case, for example, the cell specifying unit 313 specifies 24(%) calculated by dividing “1200” set to the “number of best cells” corresponding to “Cf” by“5000” set to the “reception number” as a best cell ratio corresponding to the cell Cf.

Note that, as illustrated in FIG. 25, for example, the cell specifying unit 313 may set the process result in S54 to the aggregation information DT4a.

Specifically, as illustrated in FIG. 25, for example, the aggregation information DT4a may have “best cell ratio” in which the best cell ratio calculated in S54 is set as an item. For example, the cell specifying unit 313 may set “40(%)” as the “best cell ratio” corresponding to “Cd” in the third row, may set “36(%)” as the “best cell ratio” corresponding to “Ce” in the third row, and may set “24(%)” as the “best cell ratio” corresponding to “Cf” in the third row.

Returning to FIG. 15, for example, the cell specifying unit 313 calculates an offset adjustment ratio of transmission power (hereinafter, also referred to as a transmission power offset adjustment ratio) for the contention area A specified in S52 on the basis of the best cell ratio calculated in S54 (S55).

Specifically, in the third row of the aggregation information DT4a illustrated in FIG. 25, for example, “40(%)” is set as the “best cell ratio” corresponding to “Cd”, “36(%)” is set as the “best cell ratio” corresponding to “Ce”, and “24(%)” is set as the “best cell ratio” corresponding to “Cf”. In addition, for example, the third row of the aggregation information DT4a illustrated in FIG. 25 indicates that, among the “best cell ratio” corresponding to “Cd”, the “best cell ratio” corresponding to “Ce”, and the “best cell ratio” corresponding to “Cf”, the “best cell ratio” corresponding to “Cd” is the highest. Therefore, in this case, for example, the cell specifying unit 313 specifies 1 as the transmission power offset adjustment ratio corresponding to the cell Cd. In addition, in this case, for example, the cell specifying unit 313 specifies 1.11 calculated by dividing “40(%)” set to the “best cell ratio” corresponding to “Cd” by “36(%)” set to the “best cell ratio” corresponding to “Ce” as the transmission power offset adjustment ratio corresponding to the cell Ce. Furthermore, in this case, for example, the cell specifying unit 313 specifies 1.66 calculated by dividing “40(%)” set to the “best cell ratio” corresponding to “Cd” by “24(%)” set to the “best cell ratio” corresponding to “Cf” as the transmission power offset adjustment ratio corresponding to the cell Cf.

Note that, as illustrated in FIG. 25, for example, the cell specifying unit 313 may set the process result in S55 to the aggregation information DT4a.

Specifically, as illustrated in FIG. 25, for example, the aggregation information DT4a may have “transmission power offset adjustment ratio” in which the transmission power offset adjustment ratio calculated in S55 is set as an item. For example, the cell specifying unit 313 may set “1” as the “transmission power offset adjustment ratio” corresponding to “Cd” in the third row, may set “1.11” as the “transmission power offset adjustment ratio” corresponding to “Ce” in the third row, and may set “1.66” as the “transmission power offset adjustment ratio” corresponding to “Cf” in the third row.

Returning to FIG. 15, for example, the cell specifying unit 313 calculates an offset adjustment value of transmission power (hereinafter, also referred to as a transmission power offset adjustment value) for the contention area A specified in S52 on the basis of the transmission power offset adjustment ratio calculated in S55 (S56).

Specifically, in the third row of the aggregation information DT4a illustrated in FIG. 25, for example, “1” is set as the “transmission power offset adjustment ratio” corresponding to “Cd”, “1.11” is set as the “transmission power offset adjustment ratio” corresponding to “Ce”, and “1.66” is set as the “transmission power offset adjustment ratio” corresponding to “Cf”. Therefore, in this case, for example, the cell specifying unit 313 specifies +0 (dB) calculated by multiplying a natural logarithm of “1” set to the “transmission power offset adjustment ratio” corresponding to “Cd” by 10 as the transmission power offset adjustment value corresponding to the cell Cd. In addition, in this case, for example, the cell specifying unit 313 specifies +0.4 (dB) calculated by multiplying a natural logarithm of “1.11” set to the “transmission power offset adjustment ratio” corresponding to “Ce” by 10 as the transmission power offset adjustment value corresponding to the cell Ce. Furthermore, in this case, for example, the cell specifying unit 313 specifies +2.2 (dB) calculated by multiplying a natural logarithm of “1.66” set to the “transmission power offset adjustment ratio” corresponding to “Cf” by 10 as the transmission power offset adjustment value corresponding to the cell Cf.

That is, for example, the cell specifying unit 313 specifies the transmission power offset adjustment value corresponding to each cell C such that the lower the best cell ratio calculated in S54, the larger the transmission power offset adjustment value. In other words, for example, the cell specifying unit 313 specifies the transmission power offset adjustment value corresponding to each cell C such that the lower a value indicated by the quality information (for example, reception power), the larger the transmission power transmitted from the base station device 1 corresponding to each cell C.

Specifically, for example, the cell specifying unit 313 specifies a cell C having the highest value set to the “best cell ratio” in the aggregation information DT4a. Then, for example, the cell specifying unit 313 specifies the transmission power offset adjustment value corresponding to each cell C such that as a cell C has a larger difference from a best cell ratio corresponding to a specified cell C, the transmission power offset adjustment value is larger.

Note that, as illustrated in FIG. 25, for example, the cell specifying unit 313 may set the process result in S56 to the aggregation information DT4a.

Specifically, as illustrated in FIG. 25, for example, the aggregation information DT4a may have “transmission power offset adjustment value” in which the transmission power offset adjustment value calculated in S56 is set as an item. For example, the cell specifying unit 313 may set “+0 ” as the “transmission power offset adjustment value” corresponding to “Cd” in the third row, may set “+0.4” as the “transmission power offset adjustment value” corresponding to “Ce” in the third row, and may set “+2.2” as the “transmission power offset adjustment value” corresponding to “Cf” in the third row.

Returning to FIG. 15, for example, the cell specifying unit 313 calculates a contention area load ratio for the contention area A specified in S52 on the basis of the load information (cell load ratio) calculated in S23 (S57). For example, the contention area load ratio is a ratio of a cell load ratio corresponding to each of the adjacent cells C forming the contention area A in the entire cell load ratio of the contention area A.

Specifically, for example, when the cell load ratio of the cell Cd calculated in S23 (S111) is 90(%), the cell load ratio of the cell Ce calculated in S23 (S111) is 20(%), and the cell load ratio of the cell Cf calculated in S23 (S111) is 15(%), a sum of the cell load ratio of the cell Cd, the cell load ratio of the cell Ce, and the cell load ratio of the cell Cf (hereinafter, also simply referred to as a sum of cell load ratios) is 125(%). Therefore, for example, the cell specifying unit 313 specifies 72(%) calculated by dividing “90(%)” set to the “cell load ratio” corresponding to “Cd” by the sum of the cell load ratios as the “contention area” corresponding to “Cd”. In addition, for example, the cell specifying unit 313 specifies 16(%) calculated by dividing “20(%)” set to the “cell load ratio” corresponding to “Ce” by the sum of the cell load ratios as the “contention area” corresponding to “Ce”. Furthermore, for example, the cell specifying unit 313 specifies 12(%) calculated by dividing “15(%)” set to the “cell load ratio” corresponding to “Cf” by the sum of the cell load ratios as the “contention area” corresponding to “Cf”.

Note that, for example, the cell specifying unit 313 may generate aggregation information DT4 (hereinafter, also referred to as aggregation information DT4b) including the process result in S57.

For example, the cell specifying unit 313 may store the generated aggregation information DT4b in the information storage area 330b. A specific example of the aggregation information DT4b will be described below.

### Specific Example (2) of Aggregation Information

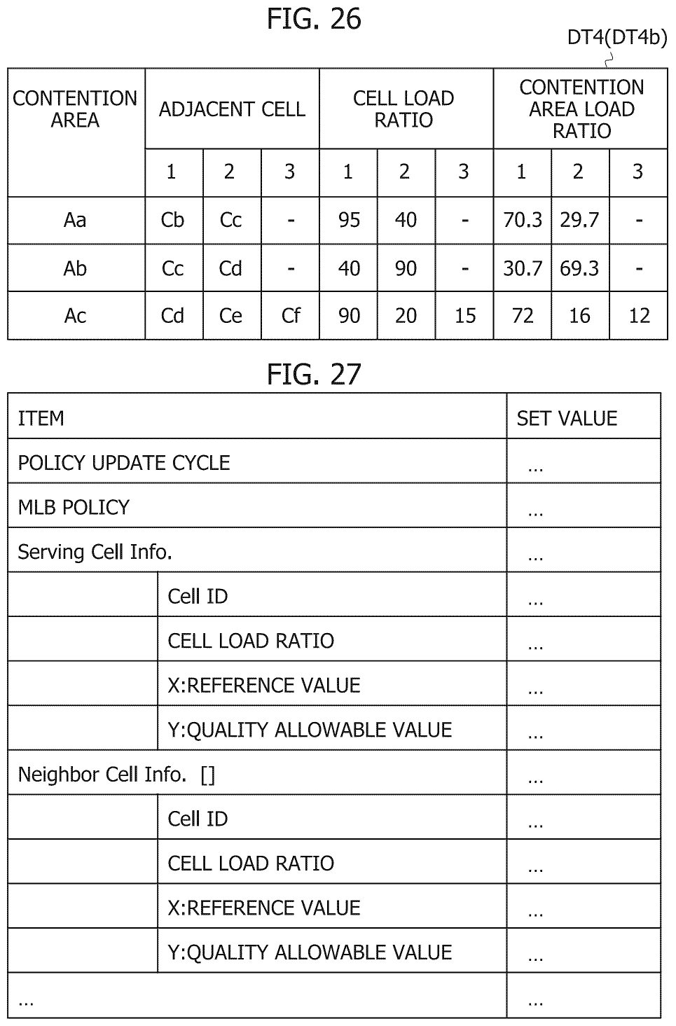

FIG. 26 is a diagram for explaining a specific example of the aggregation information DT4b. Specifically, FIG. 26 is a diagram for explaining a specific example of the aggregation information DT4b corresponding to the measurement information DT1 transmitted from the base station device 1 corresponding to the cell Ca.

For example, the aggregation information DT4b illustrated in FIG. 26 has “contention area” in which the contention area A specified in S52 is set, “adjacent cell” in which information indicating an adjacent cell C of a cell C in which the terminal device 2 is located among cells C forming the contention area A specified in S52 is set, “cell load ratio” in which a cell load ratio calculated in S23 is set, and “contention area load ratio” in which a contention area load ratio calculated in S57 is set as items.

Specifically, in the information in the first row of the aggregation information DT4b illustrated in FIG. 26, for example, “Aa” is set as the “contention area”, “Cb” and “Cc” are set as the “adjacent cell”, “95(%)” is set as the “cell load ratio” corresponding to “Cb”, “40(%)” is set as the “cell load ratio” corresponding to “Cc”, “70.3(%)” is set as the “contention area load ratio” corresponding to “Cb”, and “29.7(%)” is set as the “contention area load ratio” corresponding to “Cc”.

In addition, in the information in the second row of the aggregation information DT4b illustrated in FIG. 26, for example, “Ab” is set as the “contention area”, “Cc” and “Cd” are set as the “adjacent cell”, “40(%)” is set as the “cell load ratio” corresponding to “Cc”, “90(%)” is set as the “cell load ratio” corresponding to “Cd”, “30.7(%)” is set as the “contention area load ratio” corresponding to “Cc”, and “69.3(%)” is set as the “contention area load ratio” corresponding to “Cd”.

In addition, in the information in the third row of the aggregation information DT4b illustrated in FIG. 26, for example, “Ac” is set as the “contention area”, “Cd”, “Ce”, and “Cf” are set as the “adjacent cell”, “90(%)” is set as the “cell load ratio” corresponding to “Cd”, “20(%)” is set as the “cell load ratio” corresponding to “Ce”, “15(%)” is set as the “cell load ratio” corresponding to “Cf”, “72(%)” is set as the “contention area load ratio” corresponding to “Cd”, “16(%)” is set as the “contention area load ratio” corresponding to “Ce”, and “12(%)” is set as the “contention area load ratio” corresponding to “Cf”.

### Cell Specifying Process in Second Communication Control Device

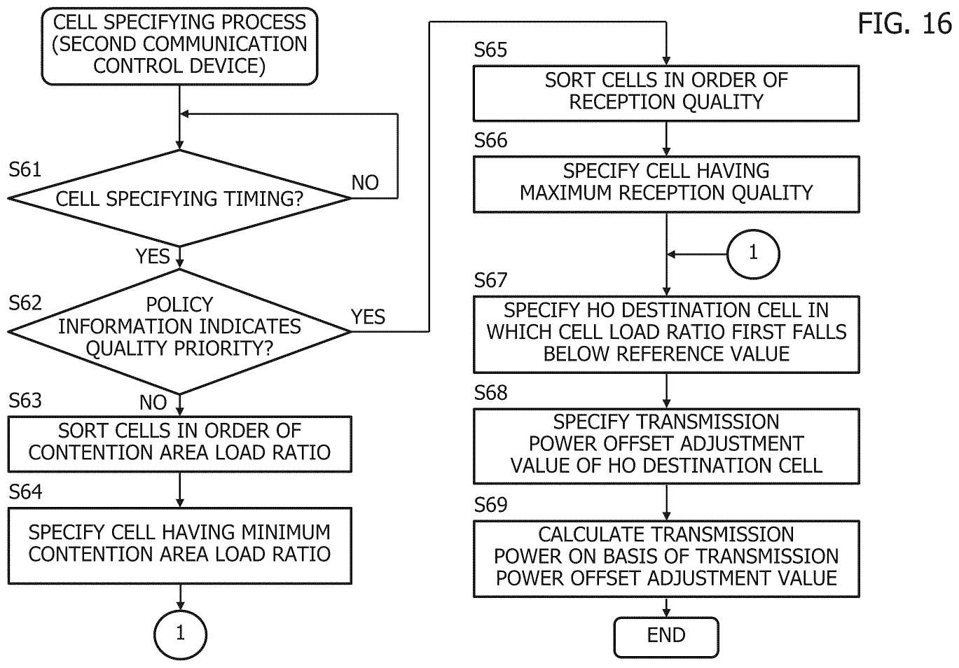

Next, process of determining an HO destination cell C (hereinafter, also referred to as cell specifying process) among pieces of communication control process in the communication control device 3b will be described. FIG. 16 is a flowchart for explaining the cell specifying process.

As illustrated in FIG. 16, for example, the cell specifying unit 313 waits until a cell determination timing is reached (NO in S61). For example, the cell determination timing may be a timing at which the policy information DT3 transmitted from the communication control device 3a in S31 is received.

Then, if the cell determination timing is reached (YES in S61), for example, the cell specifying unit 313 determines whether or not the policy included in the policy information DT3 received in S31 indicates quality priority (S62).

As a result, if the policy information DT3 received in S31 does not indicate quality priority, that is, if the policy information DT3 received in S31 indicates balancing priority, for example, the cell specifying unit 313 sorts, for each contention area A, cells C corresponding to each contention area A in order of contention area load ratio (S63).

Then, for example, the cell specifying unit 313 specifies, for each contention area A, a cell C having the minimum contention area load ratio among cells corresponding to each contention area A (S64).

Specifically, for example, in the information in the third row of the aggregation information DT4a illustrated in FIG. 26, “Ac” is set as the “contention area”, “72(%)” is set as the “contention area load ratio” corresponding to “Cd”, “16(%)” is set as the “contention area load ratio” corresponding to “Ce”, and “12(%)” is set as the “contention area load ratio” corresponding to “Cf”. Therefore, if the aggregation information DT4b generated immediately before the timing at which the policy information DT3 is received in S31 is the aggregation information DT4a illustrated in FIG. 26, for example, the cell specifying unit 313 specifies the cell Cf as a cell C having the minimum contention area load ratio among cells C corresponding to the contention area Ac.

On the other hand, if the policy information DT3 received in S31 indicates quality priority, for example, the cell specifying unit 313 sorts, for each contention area A, cells C corresponding to each contention area A in order of reception quality (S65).

Then, for example, the cell specifying unit 313 specifies, for each contention area A, a cell C having a maximum value indicating the reception quality among cells corresponding to each contention area A (S66).

Specifically, in the measurement information DT1 illustrated in FIG. 24, for example, “Ca” is set as “cell”, “10 (dB)” is set as “reception quality” corresponding to “Cd”, “5 (dB)” is set as “reception quality” corresponding to “Ce”, and “3 (dB)” is set as “reception quality” corresponding to “Cf”. Therefore, if the measurement information DT1 received immediately before the timing at which the policy information DT3 is received in S31 is the measurement information DT1 illustrated in FIG. 24, for example, the cell specifying unit 313 specifies the cell Cd as a cell C having a maximum value indicating the reception quality among cells C corresponding to the contention area Ac.

Subsequently, for example, the cell specifying unit 313 sequentially refers to the cells C sorted in S63 or S65, in other words, sequentially refers to the cells C from the cell C specified in S64 or S66, and specifies a cell C in which the cell load ratio corresponding to each cell C first falls below a reference value corresponding to each cell C as an HO destination cell C (S67).

Specifically, for example, in the information in the third row of the aggregation information DT4b illustrated in FIG. 26, “Ac” is set as “contention area”, “90(%)” is set as “cell load ratio” corresponding to “Cd”, “20(%)” is set as “cell load ratio” corresponding to “Ce”, and “15(%)” is set as “cell load ratio” corresponding to “Cf”. Therefore, if the aggregation information DT4b generated immediately before the timing at which the policy information DT3 is received in S31 is the aggregation information DT4b illustrated in FIG. 26 and the policy included in the policy information DT3 received in S31 indicates quality priority, for example, the cell specifying unit 313 refers to the “cell load ratio” corresponding to “Cd”, the “cell load ratio” corresponding to “Ce”, and the “cell load ratio” corresponding to “Cf” in this order. Here, in the policy information DT3 illustrated in FIG. 23, for example, “80(%)” is set as the “reference value” corresponding to “Cd”, “75(%)” is set as the “reference value” corresponding to “Ce”, and “70(%)” is set as the “reference value” corresponding to “Cf”. Therefore, if the policy information DT3 received in S31 is the policy information DT3 illustrated in FIG. 23, for example, the cell specifying unit 313 determines that “90(%)” which is the “cell load ratio” corresponding to “Cd” does not fall below “80(%)” which is the “reference value” corresponding to “Cd”, and “20(%)” which is the “cell load ratio” corresponding to “Ce” falls below “75(%)” which is the “reference value” corresponding to “Ce”, and specifies the cell Ce as a cell C (HO destination cell C) in which the cell load ratio first falls below the reference value.

Furthermore, for example, the power calculation unit 314 specifies a transmission power offset adjustment value corresponding to the cell specified in S67 (S68).

Specifically, in the information in the third row of the aggregation information DT4a illustrated in FIG. 25, for example, “Ac” is set as “contention area”, “+0 (dB)” is set as “transmission power offset adjustment value” corresponding to “Cd”, “+0.4 (dB)” is set as “transmission power offset adjustment value” corresponding to “Ce”, and “+2.2 (dB)” is set as “transmission power offset adjustment value” corresponding to “Cf”. Therefore, if the cell C specified in S67 is the cell Ce, for example, the cell specifying unit 313 specifies “+0.4 (dB)” set to the “transmission power offset adjustment value” corresponding to “Ce”.

Thereafter, for example, the power calculation unit 314 calculates transmission power from the base station device 1 corresponding to the cell C specified in S67 by using the transmission power offset adjustment value specified in S68 (S69).

Specifically, if the reference value of the transmission power corresponding to the cell Ce is “+3.0 (dB)”, for example, the cell specifying unit 313 calculates “+3.4 (dB)” by adding “+0.4 (dB)” set to the “transmission power offset adjustment value” corresponding to “Ce” to “+3.0 (dB)”. Then, for example, the power calculation unit 314 determines the calculated “+3.4 (dB)” as the transmission power from the base station device 1 corresponding to the cell Ce.

Note that, if the calculated transmission power (transmission power from the base station device 1 corresponding to the cell Ce) exceeds a predetermined upper limit value (hereinafter, also simply referred to as an upper limit value), for example, the power calculation unit 314 may determine the transmission power from the base station device 1 corresponding to the cell Ce as the upper limit value.

### Information Transmission Process in Second Communication Control Device

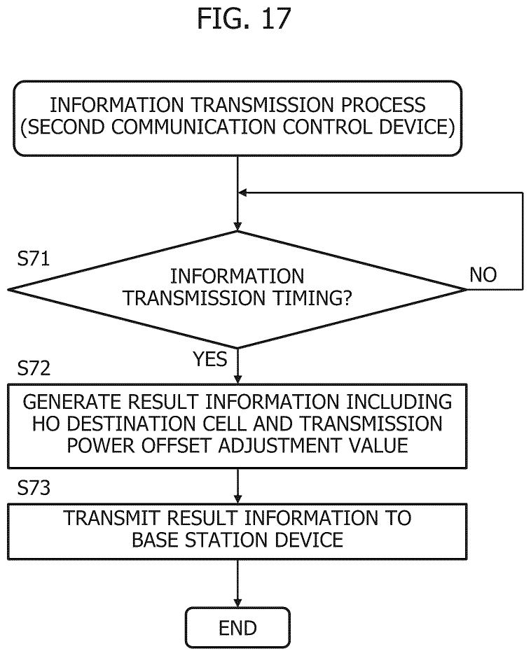

Next, process of transmitting information (hereinafter, also referred to as result information) indicating a process result in the cell specifying process to the base station device 1 (hereinafter, also referred to as information transmission process) among pieces of communication control process in the communication control device 3b will be described. FIG. 17 is a flowchart for explaining the information transmission process.

As illustrated in FIG. 17, for example, the information transmission unit 315b waits until an information transmission timing is reached (NO in S71). For example, the information transmission timing is a timing after the cell specifying process is performed.

If the information transmission timing is reached (YES in S71), for example, the information transmission unit 315b generates result information including the information indicating the HO destination cell C specified in S67 and the information indicating the transmission power calculated in S69 (S72).

Thereafter, for example, the information transmission unit 315b transmits the result information generated in S72 to the base station device 1 (the base station device 1 corresponding to the policy information DT3 received in S31) (S73).

As a result, for example, the base station device 1 that has transmitted the policy information DT3 can perform handover of the terminal device 2 located in the cell C corresponding to its own device 1 by referring to the result information transmitted from the communication control device 3. Specifically, for example, by transmitting and receiving necessary information to and from the base station device 1 corresponding to the HO destination cell C indicated by the result information transmitted from the communication control device 3, the base station device 1 that has transmitted the policy information DT3 can perform handover of the terminal device 2 located in the cell C corresponding to its own device.

Note that, in S72, for example, the information transmission unit 315b may generate result information including the transmission power offset adjustment value specified in S68 instead of the transmission power calculated in S69 or together with the transmission power calculated in S69.

As described above, for example, the communication control device 3 in the present embodiment receives the quality information indicating communication quality and the load information indicating communication load for each of the plurality of adjacent cells C adjacent to the target cell C from the base station device 1. Then, for example, the communication control device 3 in the present embodiment calculates a reference value indicating an upper limit value of the load information in which the quality information in each adjacent cell C satisfies the first condition for each of the plurality of adjacent cells C on the basis of the quality information and the load information corresponding to each adjacent cell C.

Subsequently, for example, the communication control device 3 in the present embodiment specifies one or more adjacent cells C whose load information at a predetermined timing is equal to or less than the reference value among the plurality of adjacent cells C, and specifies any adjacent cell C among the one or more adjacent cells C as an HO destination cell C on which the terminal device 2 located in a target cell C performs handover at a predetermined timing on the basis of respective pieces of quality information corresponding to the specified one or more adjacent cells C.

Thereafter, for example, the communication control device 3 in the present embodiment transmits information indicating the specified HO destination cell C to the base station device 1 corresponding to the target cell C.

That is, for example, the communication control device 3 in the present embodiment selects an adjacent cell C (HO destination cell C) of a handover destination of the terminal device 2 in a contention area A from adjacent cells C that can be determined to be able to maintain minimum required communication quality.

As a result, for example, the communication control device 3 in the present embodiment can perform load balancing among the base station devices 1 while suppressing quality degradation in the terminal device 2.

Note that, for example, the policy information DT3 transmitted from the communication control device 3a to the communication control device 3b by using the A1 interface may be transmitted according to the format illustrated in FIG. 27.

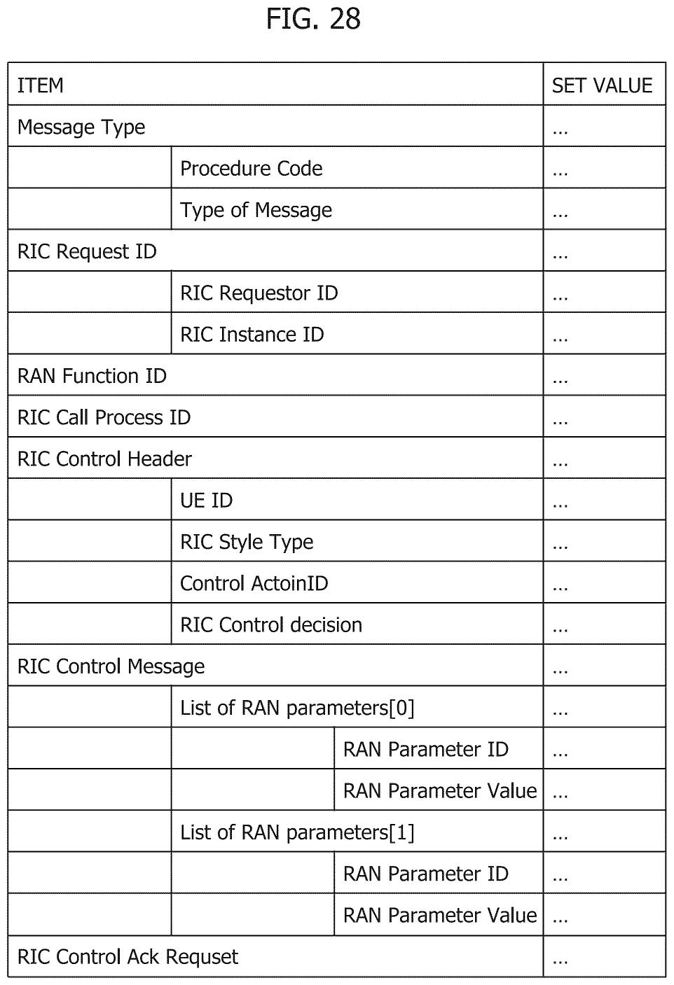

In addition, for example, the result information transmitted from the communication control device 3b to the base station device 1 by using the E2 interface may be transmitted according to the format illustrated in FIG. 28. Specifically, in the example illustrated in FIG. 28, for example, a value indicating the HO destination cell C specified in S67 may be set in “RAN Parameter Value” of “List of RAN parameters [0]” of “RIC Control Message”. In addition, in the example illustrated in FIG. 28, for example, the transmission power offset adjustment value specified in S68 may be set in “RAN Parameter Value” of “List of RAN parameters [1]” of “RIC Control Message.” The above embodiment is summarized as the following supplementary notes.

According to one aspect, it is possible to perform load balancing among base station devices while suppressing quality degradation in a terminal device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication control device comprising:
a memory; and
a processor coupled to the memory and the processor configured to:
receive quality information indicating communication quality and load information indicating a communication load for each of a plurality of cells adjacent to a specific cell from a base station device;
specify any one of the plurality of cells as a first cell on which a terminal device located in the specific cell performs handover at a predetermined timing on a basis of the load information and the quality information for each of the plurality of cells at the predetermined timing; and
transmit information indicating the specified first cell to the base station device.

2. The communication control device according to claim 1,
the processor configured to calculate, for each of the plurality of cells, a reference value of quality information indicating a lower limit value of the quality information satisfying a first condition in each cell or a reference value of load information indicating an upper limit value of the load information in which the quality information satisfies the first condition on a basis of the quality information and the load information corresponding to each cell,
wherein the processor specifies the first cell on a basis of the reference value of the quality information or the reference value of the load information.

3. The communication control device according to claim 2, wherein the processor specifies any one of the plurality of cells in which the quality information at the predetermined timing exceeds the reference value of the quality information or the load information at the predetermined timing falls below the reference value of the load information as the first cell.

4. The communication control device according to claim 1, wherein the processor specifies a cell having a maximum value indicated by the quality information at the predetermined timing among the plurality of cells as the first cell.

5. The communication control device according to claim 1, wherein the processor specifies a cell in which the load information at the predetermined timing satisfies a second condition among the plurality of cells as the first cell.

6. The communication control device according to claim 5, wherein the processor specifies a cell having a minimum value indicated by the load information at the predetermined timing among the plurality of cells as the first cell.

7. The communication control device according to claim 1,
the processor configured to calculate transmission power to the terminal device in the first cell according to the quality information in the first cell.

8. The communication control device according to claim 7, wherein the processor specifies a second cell having a maximum value indicated by the quality information among the plurality of cells, and calculates the transmission power in the first cell such that an increase amount of the transmission power in the first cell increases as a difference between a value indicated by the quality information corresponding to the first cell and a value indicated by the quality information corresponding to the second cell increases.

9. A non-transitory computer-readable storage medium storing therein a communication control program for causing a computer to execute a process comprising:
receiving quality information indicating communication quality and load information indicating a communication load for each of a plurality of cells adjacent to a specific cell from a base station device;
specifying any one of the plurality of cells as a first cell on which a terminal device located in the specific cell performs handover at a predetermined timing on a basis of the load information and the quality information for each of the plurality of cells at the predetermined timing; and
transmitting information indicating the specified first cell to the base station device.

10. The non-transitory computer-readable storage medium storing therein the communication control program according to claim 9,
the communication control program further causing a computer to execute a process comprising:
calculating transmission power to the terminal device in the first cell according to the quality information in the first cell.

11. A communication control method in which a computer executes a process comprising:
receiving quality information indicating communication quality and load information indicating a communication load for each of a plurality of cells adjacent to a specific cell from a base station device;
specifying any one of the plurality of cells as a first cell on which a terminal device located in the specific cell performs handover at a predetermined timing on a basis of the load information and the quality information for each of the plurality of cells at the predetermined timing; and
transmitting information indicating the specified first cell to the base station device.

12. The communication control method according to claim 11,
wherein a computer further executes a process comprising:
calculating transmission power to the terminal device in the first cell according to the quality information in the first cell.
